(19) United States
(12) Patent Application Publication
(10) Pub. No.: US 2005/0034349 A1
(43) Pub. Date: Feb. 17, 2005

(54) Sound Emitting fishing lure

(76) Inventor: Randle Lee Dugger II, Bakersfield, CA (US)

Correspondence Address: Randle L. Dugger II, 119 Harding Avenue, Bakersfield, 93308-4311, CA

(21) Appl. No.: 10/624,734

(22) Filed: Jul. 21, 2003

(51) Int. Cl. A01K 79/02

(52) U.S. Cl. 43/17.1

(57) ABSTRACT

The disclosed apparatus can be adapted to work in most fishing lures. The apparatus allows the manufacture to adjust the sound(s) emitted by said fishing lure over a wide range, from several thousand hertz down to tens of hertz or lower. The hertz produced by one embodiment of the apparatus can be lowered to the point that the targeted game fish can interpret the action induced into the fishing lure by the disclosed invention more as movement of the fishing lure rather than sound emitted from the fishing lure. The apparatus obtains the energy it requires to operate from the movement of the fishing lure. One embodiment of the disclosed invention comprises a generic shell (top water fishing lure shell), a tuning fork and a pendulum. The stem of tuning fork is mounted to the inside wall of the shell, the pendulum is rotatably mounted to the interior wall of the shell in such a manner as to allow the weighted end of the pendulum to strike the tuning fork while the fishing lure is in use.

### BACKGROUND OF THE INVENTION

The disclosed invention relates generally to fishing tackle and more specifically to an apparatus capable of emitting a tuned sound or a combination of sounds to attract fish.

It has long been known that fish are attracted to sound, and that fish are attracted to certain frequencies of sound more than others. Yet, to date, the only fishing lures that can be tuned to emit sound in a narrow frequency range have required elaborate electronic circuits, speakers, and batteries. In addition, none of these components were designed to take the tremendous battering associated with the everyday use the average fishing lure endures, thereby doming this type of apparatus to failure. The instant invention, on the other hand, lends itself well to the riggers of constantly being cast into the water and retrieved. The present invention can be tuned to emit a wide spectrum of sounds, and it accomplishes this without an internal power supply. The disclosed invention uses only the movement of the fishing lure it is housed in as a power source to manufacture sound. There are numerous lures produced today that emit sound, but for the most part the sound they emit is white noise made by using small pieces of metal encapsulated within the lure to make a rattling sound or something similar. Other fishing lures are designed to disturb the water in some way either by creating splashing sounds, or by oscillating as they are retrieved. But to date no one has succeeded in producing a line of mechanically operated fishing lures capable of being tuned by the manufacture to emit a frequency the manufacture believes to be most attractive to a specific species of fish.

### SUMMARY OF THE INVENTION

The present invention is directed to an apparatus which meets the needs identified above. The present invention enables the manufacture to set the frequency or frequency range at which the lure emits sound, allowing for a full line of custom lures each targeting a specific species of game fish in either salt water or fresh water, furthermore the instant invention is durable enough to withstand years of normal use. In one embodiment the apparatus is a tuning fork and a striker used to activate the tuning fork. The apparatus is mounted inside a fishing lure. Once struck, the tuning fork transmits the frequency(s) it is tuned to into the water. This apparatus will allow the manufacture to tune a lure to a frequency(s) that the manufacture wishes to use to target a specific species of game fish. An alternate method of producing a tuned, but somewhat less pure sound is also disclosed. This is accomplished by using a piece of spring steel “a comb” with one or more teeth cut into it. A nib or pick is mounted on a pendulum, and as the pendulum swings the nib or pick bends the spring steel from its resting position and then releases it producing a sound. This same method is used to produce the sound from a music box. A nib or pick can also be used to activate a tuning fork.

The instant invention can be placed in a multitude of body styles, either replacing the existing noise emitter or in combination with the existing emitter to enhance the attractiveness of the lure.

One embodiment of the apparatus is comprised of a tubular shaped, watertight, housing (shell) closed at each end in the general shape of a capsule or torpedo. A tuning fork is attached at some point to the interior wall of the torpedo shaped housing (shell). The shell is weighted in such a way as to allow one section of the shell to always remain oriented downward while it's floating in water, hereafter referred to as the bottom of the shell. A thin wire having two ends is used as a striker guide. At some point along the bottom of the shell one end of wire is attached. This wire runs rearward and upward at an angle between the tine of the tuning fork until it contacts the inside top of the housing where the second end of the wire is attached. This wire is the guide for the striker; the striker can be any shape. For simplicity, in this embodiment we are using a barrel shaped striker. The striker has a hole through it allowing it to be slide mounted on the striker guide so that it will slide up and down the guide freely. At rest, the angle of the striker guide must be great enough to allow the striker to slide down the striker guide to the bottom. The angle of the striker guide must be small enough to allow the striker to slide up the striker guide to make contact with the tuning fork when the lure is jerked forward. The striker, being at rest, tends to remain at rest. As the lure moves forward the striker moves up the striker guide until it intersects the tuning fork, strikes the tuning fork and rebounds back to the bottom.

An alternative to the striker and striker guide in the aforementioned embodiment is to replace the sliding striker and guide with a pendulum and a pendulum axle. The pendulum can be mounted vertically, horizontally or any angle in between as long as it is mounted in such a manner as to allow it to strike the tuning fork once the lure is jerked forward. A spring can be added to hold the pendulum in a ready position. The pendulum is rotatably mounted on an axle in such a way as to allow the weighted end of the pendulum to swing from one side of the interior wall to the other side of the interior wall. And is mounted in such a manner as to allow the weighted end of the pendulum, or a nib mounted on the pendulum to come into contact with the tuning fork as the fishing lure is jerked forward. As the lure is jerked forward, the weighted end of the pendulum moves in the opposite direction of the shell. This action rotates the weighted end of the pendulum to a point where it strikes the tuning fork, and then, the pendulum rebounds, swinging in an ever decreasing arc until the pendulum runs out of momentum or is activated once again by a second jerk on the fishing line. The pendulum striking, and then, rebounding from the tuning fork causes the tuning fork to vibrate. The tuning fork is mounted to the shell so the vibrations are transferred to the shell. The shell is in contact with the water; therefore, the shell transfers the vibration to the water thus attracting fish.

In this next embodiment, the apparatus is comprised of a tubular shaped, watertight, housing closed at each end in the shape of a capsule or torpedo. A tuning fork is attached at some point to the interior wall of the shell. The housing is weighted in such a way as to allow one section of the housing to always remain oriented downward while the apparatus is floating in water, hereafter called the bottom of the shell. A small tube is attached to the bottom running rearward and upward at an angle to a point just short of contacting the tuning fork. This small tube is the striker guide. The striker is round and is inside the striker guides tube. There is enough clearance between the striker and the striker tub to allow the striker to move freely in the tube. When the fishing lure is jerked forward, the striker travels up the striker tube and strikes the tuning fork and then the striker rebounds, causing the tuning fork to vibrate.

In this embodiment, the disclosed invention is housed in a short bodied waterproof, generic, fish shape shell referred to in the industry as a crankbait. These types of lures are produced in a multitude of sizes, colors, and with variations to the outer shell such as where the eyelet is located, that is used to attach the fishing line to the fishing lure. Some crankbaits have bills some do not. However all crankbaits have one thing in common; they all oscillate from side-to-side as they are used. A tuning fork is attached at some point along the interior wall of the fish shaped housing or shell. The striker is a pendulum having a hinged end, and a weighted end. The hinged end is attached to the interior of the housing or shell in such a way as to allow the weighted end to strike the tuning fork as the lure oscillates.

Components of all embodiments are interchangeable from one embodiment to another, i.e. a slide mounted striker in a top water fishing lure can be replaced with a pendulum striker and vice-versa, and a tuning for can be replaced with a comb and vice-versa. Additionally, most of the shells or housings used to encapsulate the disclosed invention are formed using injection molding.

The tuning fork and comb can be manufactured in such a way as to allow either or both to vibrate at such a low hertz as to produce more of a movement in the fishing lure than a sound.

The heretofore mentioned, and other features, aspects, and advantages of the instant invention will become better understood with regard to the following description, appended claims, and accompanying drawings.

### BRIEF DESCRIPTION OF THE DRAWINGS

FIG. 1 is a view of the disclosed invention mounted in a generic torpedo shaped housing with one half of the housing removed.

FIG. 2 is a partially exploded view of FIG. 1

FIG. 3 is a view of the instant invention mounted in a generic torpedo shaped housing with one-half of the housing removed, showing one of several possible alternate type of strikers.

FIG. 4 is an exploded view of FIG. 3

FIG. 5 is a view of the disclosed invention mounted in a generic fish shaped housing that attempts to mimic a shad or pan fish. Most, but not all, of the fishing lures with this general shape are known in the industry as “crank baits”.

FIG. 6 is an exploded view of FIG. 5

FIG. 7 is a view of the disclosed apparatus mounted in a generic fish shaped housing that attempts to mimic a long narrow fish like a minnow. Most, but not all of the housing with this general shape are known in the industry as “jerk baits.” In this particular embodiment the tuning fork is hinge mounted and moves from side to side contacting the stickers mounted in the walls of the housing.

FIG. 8 is an exploded view of FIG. 7

FIG. 9 uses the same housing as FIGS. 1 through 4. However, the tuning fork is mounted in the front of the housing in this embodiment and a pendulum is mounted in the rear of the unit and is used to strike the tuning fork.

FIG. 10 shows an alternate method of producing sound in a top water lure, replacing the tuning fork with a comb while using a pendulum to load and release the tooth of the comb, which causes the comb to vibrate.

FIG. 11 shows an alternate method of producing sound in a crank bate, replacing the tuning fork with a pence of spring and using a pendulum to load and release it.

FIG. 12 uses the same shell and tuning fork as FIGS. 1 through 4. with the tuning fork mounted in the rear of the unit and a pendulum striker mounted in the front of the apparatus.

FIG. 13 uses the same shell and tuning fork as FIGS. 1 through 4 with another variation on the pendulum striker.

FIG. 14 uses the same shell and tuning fork as FIGS. 1 through 4 with a variation on the slide mounted striker. In this embodiment, the striker can be mounted in numerous positions; the striker relies on a spring to hold it in a ready position.

FIG. 15 is a close-up of one embodiment of the disclosed invention without a housing.

FIG. 16 is a close-up of one embodiment of the disclosed invention minus the housing.

FIG. 17 is a close-up of an alternate method of powering the disclosed invention in that this apparatus transforms the pendulums bidirectional swinging motion to a unidirectional motion via a ratcheting gear allowing the drum and nibs to rotate in a single direction.

### DRAWING CROSS-REFERENCE

Figure One
101L-Left half, exterior housing. (shell)
101R-Right half, exterior housing. (shell)
102R-Interior walls of shell.
103-Eyelet to attach fishing line.
104-Generic treble hook and eyelet attachment.
105-Tuning fork.
106-stem end of tuning fork.
107-Tuning fork tines.
110-Striker.
111-Striker guide

Figure Two
201L-Left half, exterior housing. (shell)
201R-Right half, exterior housing. (shell)
202R-Interior walls of shell.
203-Eyelet to attach fishing line.
204-Generic fishing hook and eyelet.
205-Tuning fork.
206-Stem end of tuning fork.
207-Tuning fork tines.
210-Striker
211-Striker guide.

Figure Three
301L-Left half exterior housing. (shell)
301R-Right half, exterior housing. (shell)
302R-Interior walls of shell.
303-Eyelet to attach fishing line.
304-Generic treble hook and eyelet.
305-Tuning fork.
306-Tuning fork stem.
307-Tuning fork tines.
308L-Left side of the first end of the striker guide tube.
308R-Right side of the first end of the striker guide tube.
309L-Left side of the second end of the striker guide tube.
309R-Right side of the second end of the striker guide tube.
310-Striker.
311R-Right half of striker guide tube.
311L-Left half of striker guide tube.

Figure Four
401L-Left half, exterior housing (shell)
401R-Right half, exterior housing. (shell)
402-Interior walls of shell.
403-Eyelet to attach fishing line.
404-Generic treble hook and eyelet attachment.
405-Tuning fork.
406-Tuning fork stem.
407-Tuning fork tines.
408L-Left side of the first end of the striker guide tube.
408R-Right side of the first end of the striker guide tube.
409L-Left side of the second end of the striker guide tube.
409R-Right side of the second end of the striker guide tube.
410-Striker.
411R-Right half striker guide tube.
411L-Left half striker guide tube.

Figure Five
501L-Left half, exterior housing. (shell)
501R-Right half, exterior housing. (shell)
502R-Interior walls of shell.
503-Eyelet to attach fishing line.
504-Generic fishing hook and eyelet.
505-Tuning fork.
506-Tuning fork stem.
507-Tuning fork tines.
510-Striker
519-Striker support and pivot pin.
520-First end of striker support and pivot pin.
521-Second end of striker support and pivot pin.

Figure Six
601L-Left half, exterior housing.
601R-Right half, exterior housing.
602R-Interior walls of shell.
603-Eyelet to attach fishing line.
604-Generic treble hook and eyelet attachment.
606-Tuning fork stem.
607-Tuning fork tines.
610-Striker
619-Striker support and pivot pin.
620-First end of the striker support and pivot pin.
621-Second end of the striker support and pivot pin.

Figure Seven
701L-Left half, exterior housing.
701R-Right half, exterior housing.
702R-Interior walls of shell.
703-Eyelet to attach fishing line.
704-Generic fishing hook and eyelet.
705-Tuning fork.
706-Tuning fork stem.
707-Tuning fork Tines.
710L-Left striker.
710R-Right striker.
722-Tuning fork axle, pivot support and mounting pin.
723-First end of the pendulum axle.
724-Second end of the pendulum axle.
725-Tuning fork pivotally mounted support sleeve.

Figure Eight
801L-Left half, exterior housing.
801R-Right half exterior housing.
802-Interior walls of shell.
803-Eyelet to attach fishing line.
804-Generic treble hook and eyelet attachment.
805-Tuning fork.
806-Tuning fork stem.
807-Tuning fork tines.
810L-Left striker.
810R-Right striker.
822-Tuning fork axle, support and mounting pin.
823-First end of the pendulum axle.
824-Second end of the pendulum axle.
825-Tuning fork pivotally mounted support sleeve.

Figure Nine
901L-Left half exterior housing. (shell)
901R-Right half exterior housing. (shell)
902R-Interior walls of housing.
903-Eyelet to attach fishing line.
904-Generic Fishing hook and eyelet.
905-Tuning fork.
906-Tuning fork stem.
907-Tuning fork tines.
910-Striker.
912-Pendulum.
913-Pendulum axle.
914-First end of the pendulum axle.
915-Second end of the pendulum axle.

Figure Ten
1001L-Left half housing. (shell)
1001R-Right half housing. (shell)
1002R-Interior walls of housing.
1003-Eyelet to attach fishing line.
1004-Generic fishing hook and eyelet attachment.
1010-Pick.
1012-Pendulum.
1013-Pendulum axle.
1014-First end of the pendulum axle.
1015-Second end of the pendulum axle.
1016-Pendulum pivotally mounted support sleeve.
1017-Mounted end of spring steel.
1018-Tooth end of spring steel.

Figure Eleven
1101L-Left half housing. (shell)
1101R-Right half housing. (shell)
1102R-Interior walls of housing.
1103-Eyelet to attach fishing line.
1104-Generic Fishing hook and eyelet.
1110-Nib or pick.
1112-Pendulum.
1113-Pendulum axle.
1114-First end of the pendulum axle.
1115-Second end of the pendulum axle.
1116-Pendulum pivotal mounting sleeve.
1117-Mounted end of spring steel.
1118-Tooth end of spring steel.

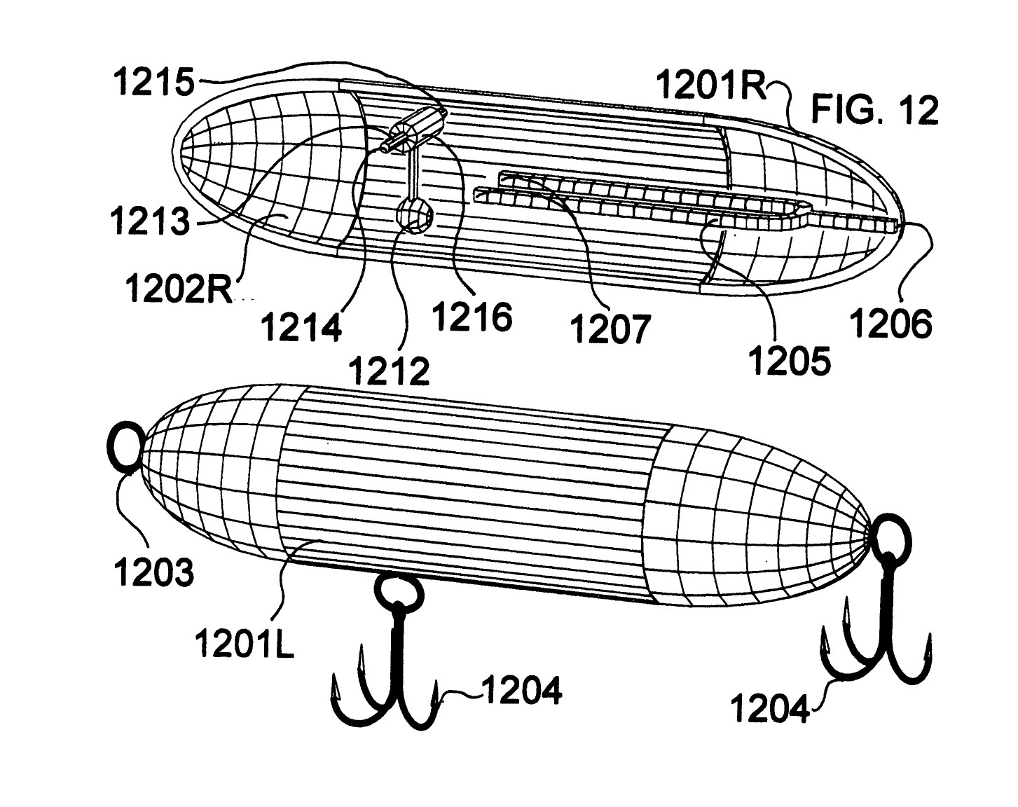

FIG. 12
1201L-Left half housing. (shell)
1201R-Right half housing. (shell)
1202R-Interior walls of housing
1205-Tuning fork.
1206-Tuning fork stem.
1207-Tuning fork tines.
1212-Pendulum.
1213-Pendulum axle.
1214-First end of the pendulum axle.
1215-Second end of the pendulum axle.
1216-Pendulum pivotally mounted support sleeve.

Figure Thirteen
1301R-Right half of housing. (shell)
1302R-Interior walls of housing. (shell)
1305-Tuning fork.
1306-Tuning fork stem.
1307-Tuning fork tines.
1327-Nylon, spring or plastic support.
1328-Tuning fork stem support.

Figure Fourteen
1401R-Right side of housing. (shell)
1402R-Interior walls of housing. (shell)
1405-Tuning fork.
1406-Tuning fork stem.
1407-Tuning fork tines.
1410-Striker
1411-Striker guide
1429-Flat piece of spring steel.
1430-Contact point of striker

Figure Fifteen
1510-Nib or pick
1512-Pendulum.
1516-Pendulum pivotal mounting sleeve and drum.
1517-Mounting end of comb
1518-Tooth or teeth end of comb.

Figure Sixteen
1605-Tuning fork.
1606-Stem end of tuning fork.
1634-Tine weights

Figure Seventeen
1710-Nib or pick.
1712-Pendulum.
1713-Pendulum axle.
1714-First end of the pendulum axle.
1715-Second end of the pendulum axle.
1731-Flat piece of spring steel.
1732-Ratching gears.
1733A-Pendulum Pivotal mounting sleeve.
1733B-Nib Drum.

### DETAILED DESCRIPTION OF THE EMBODIMENTS

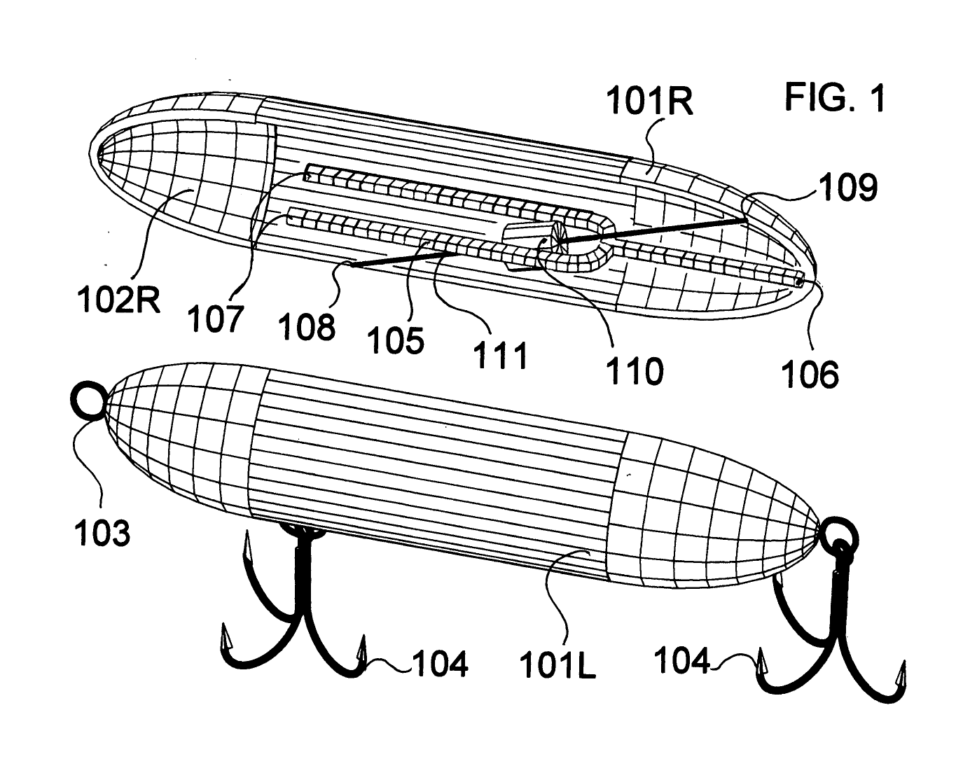

Referring now specifically to the drawing in FIG. 1. this embodiment of the disclosed invention is housed in a class of fishing lures known generally as top water lures. Top water lures are produced in a multitude of sizes, colors, and with small variations to the outer shell such as blunt noses to disturb more water when they are jerked forward, but they all have the same general shape and are retrieved with a jerking motion that lends itself well to the instant invention. FIG. 1 shows one of the embodiments of the disclosed apparatus. This embodiment is comprised of a waterproof shell 101R and 101L. The shell is tubular shaped and enclosed at each end with a parabolic shaped cap forming a one piece waterproof, somewhat capsule or torpedo shaped shell. This type of shell is most commonly formed by injection molding. The shell has been dissected into 101R, 101L. 101L has been removed to expose the interior of the fishing lure where the disclosed invention is housed. The shell has an interior wall 102R, 102L, an eyelet 103 which is attached to the exterior of the shell at one end to allow the fishing line to be attached to the fishing lure. Hereafter, in all embodiments referred to as a top water fishing lures, the end of the shell containing eyelet 103 will be considered the front end of the shell. On the opposite end of the shell is mounted a generic treble hook 104; hereafter, referred to as the back end or rear of the shell. The shell is weighted in such a manner as to allow one longitudinal portion to remain oriented downward while floating in water; this portion is thereafter referred to as the bottom of the shell.

A tuning fork 105, having a first end 106, the stem end. The stem end 106 is attached at some point to the interior wall of the shell; the exact placement of the tuning fork attachment will depend on several factors included, but not limited to, the balance of the overall unit, the frequency being produced by the tuning fork, and the overall volume of the sound that is desired. In FIG. 1, the tuning fork is attached at the rear of the shell for simplicity. The tuning fork having a second end, the tine end 107, which hangs free in the air space in the interior of the shell; a striker guide 111 having a first end 108 and a second end 109. The striker guide can be of any design, such as a small tube, a string, or anything that will hold the striker in place and allow it to contact the tuning fork once the fishing lure is jerked forward. For simplicity in FIG. 1, a small piece of wire is used as the striker guide. The first end of the striker guide 108 is attached to the bottom of the shell forward and below of the second end The second end of the striker guide 109 is attached to the top of the shell rearward and above the first end, thus forming an angle in relationship to the shell; the angle must be great enough to allow the striker to slide down to the bottom of the shell toward the first end of the Striker guide while the lure is at rest. The exact placement of the striker guide and mounting angle of the striker guide will depend on the how the individual fishing lure is orientated in the water. The angle of the striker guide 111 must be small in relationship to the shell to allow the striker to travel up the striker guide and strike the tuning fork when the fishing lure is jerked forward. The striker guide must be mounted in relationship to the tuning fork as to allow the striker to contact the tuning fork when the striker travels up the striker guide.

The striker 110 is mounted on the striker guide. The striker can be of any shape desired, and the striker can be made of any material capable of transferring energy to the tuning fork once it strikes the tuning fork. In the prototypes, we have used small ball and barrel shaped strikers, made of tungsten, stainless steel, brass, copper, aluminum and plastics. All of these materials work, each produce a unique sound as they strike the tuning fork. For simplicity in FIG. 1, a longitudinally mounted barrel shaped striker is used. While the fishing lure is at rest the striker 110 is located at the bottom forward most end of the striker guide 108. Once the fishing lure is jerked forward, the striker slides up the guide striking the tuning fork 105 then rebounds back to the bottom of the guide ready to be activated again.

A variation of the above embodiment would be to increase the diameter of the wire used as the striker guide to the point that it could support the striker 105 with only the first end 108 attached to the shell This design would allow for a more compact design.

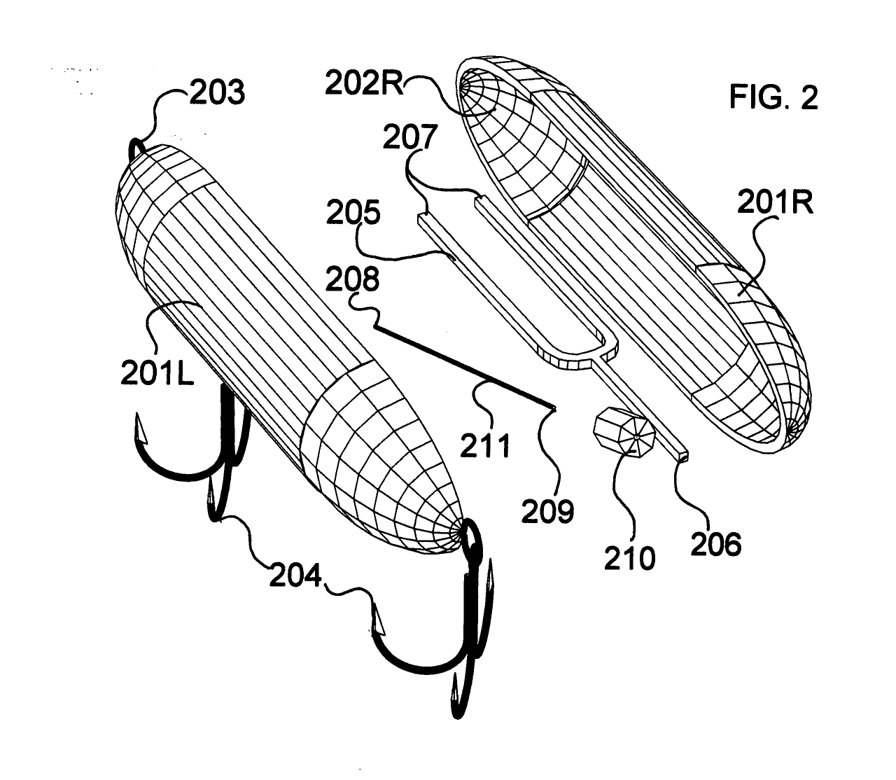

FIG. 2 is a partially exploded view of FIG. 1

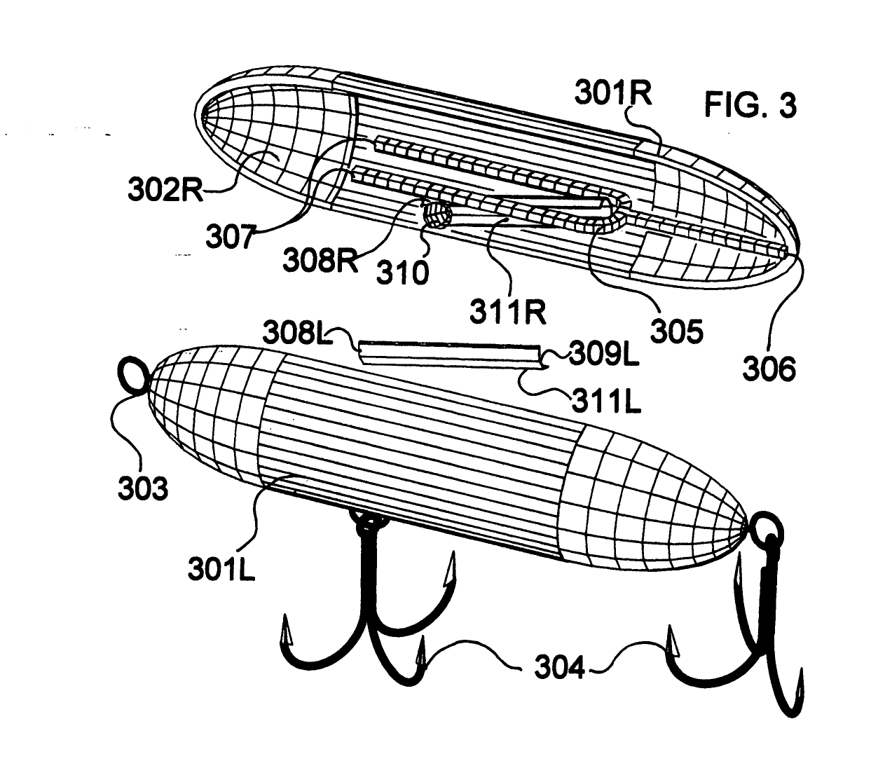

FIG. 3 is eccentrically the same as FIGS. 1 and 2, with one notable exception. The striker guide 311. The striker guide 311 having a first end 308R, 308L and a second end 309R, 309L. In practice the right and left half's of the striker tube form a single tube that supports the striker on the interior wall of the striker guide. In FIG. 3, the striker guide tube has been split lengthwise and the left half of the striker guide has been removed for clarity. The striker guide tube has two ends; a first end 308R, and 308L which is attached to the interior wall of the shell at the bottom forward of the second end, and a second end 309R, 309L that is rearward and above the first end at an angle stopping just short of the tuning fork 305. The second end of the striker guide tube 309R, 309L is close enough to the tuning fork 305 to keep the striker 310 from exiting the striker guide tube when the striker is accelerated up the tube by jerking the fishing lure forward. The only difference in the striker in FIG. 3 in comparison to FIGS. 1 and 2 is that the striker in FIG. 3 does not require a hole in it for support since the striker is supported on its outer surface by the striker tube.

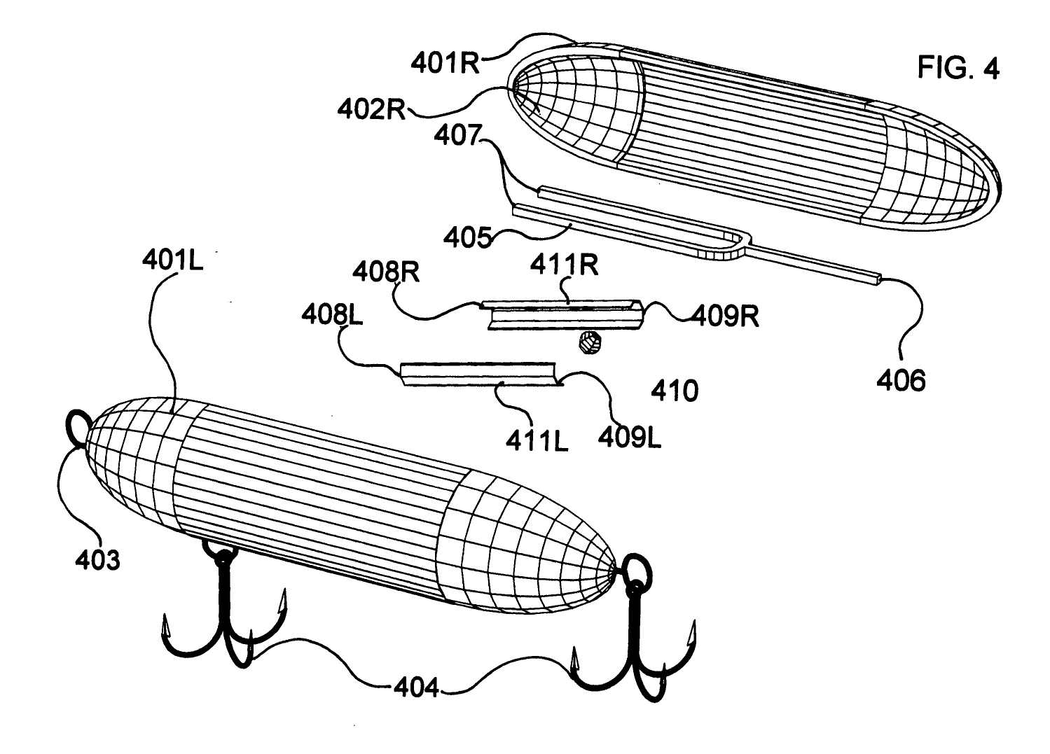

FIG. 4 is a partially expanded view of FIG. 3

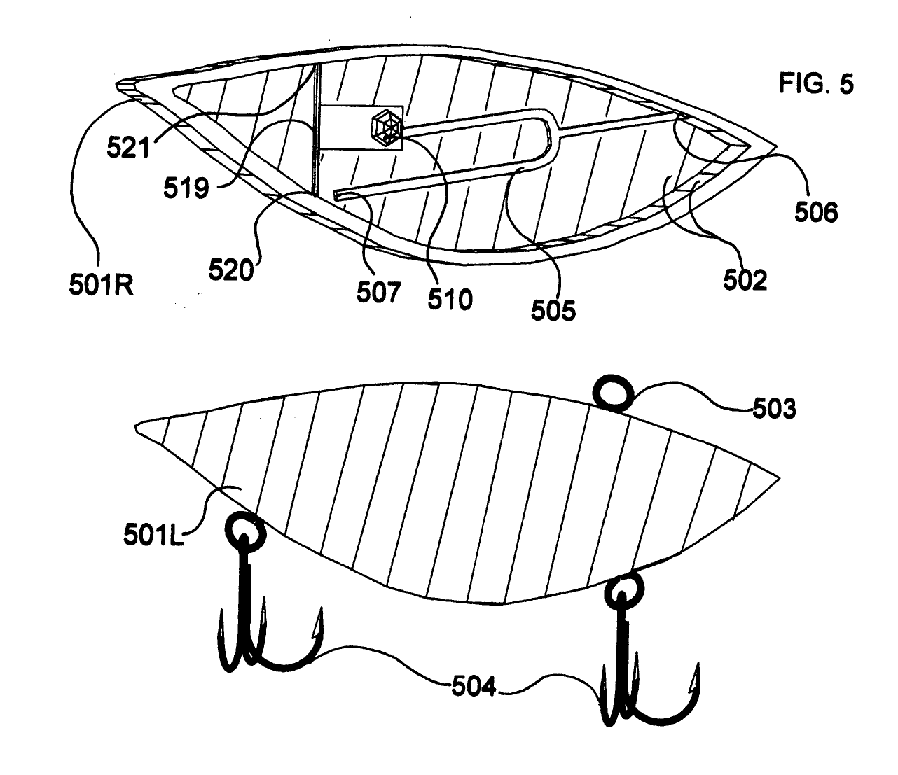

FIG. 5. In this embodiment, the disclosed invention is housed in a short bodied waterproof generic fish shape shell referred to in the industry as a crankbait, 501R and 501L. Crankbaits come in a myriad of colors and sizes, as well as a variation in body styles. However, they all have one thing in common, while in use they are designed to oscillate from side-to-side, which is true whether they are retrieved at a somewhat steady pace, jerked, or trolled. In this embodiment, the disclosed inventing is designed to be activated by the side-to-side motion of a crankbait, and most other fishing lure that moves from side-to-side while in use.

The instant invention is comprised of a waterproof housing 501R and 501L, the shell with one or more generic hooks 504, an eyelet 503 to attach the fishing line, a tuning fork 505, having a first end 506 and a second end 507. The first end of the tuning fork is attached to the interior wall of the shell at some point, but the specific point at which the tuning fork is mounted will vary depending on the type, and volume of the sound the fishing lure is required to emit to attract a given species of fish. The second end of the tuning fork hangs free in the air cavity inside the shell. A striker support and pivotal mounting pin 519 having a first end 520 and a second end 521. The first end of the pivotal mounting pin 520 is rotatably mounted on the interior wall of the shell at the bottom of the shell. The second end of the pivotal mounting pin is rotatably mounted in the interior wall of the shell at the top of the shell. A striker 510 is mounted on the pivotal mounting pin in such a manner as to allow the striker to swing from side-to-side within the shell. In this embodiment, the striker is mounted in a fashion that will allow it to strike the tuning fork once while the pendulum swings in one direction and the interior wall of the shell while the pendulum swings in the other direction.

A variation of the above embodiment would be to place a drum like device in the wall of the shell where the striker contacts the shells interior wall allowing the manufacture more control of the sound the fishing lure emits by choosing the material the drum is made of and by adjusting the size of the drum.

A second variation on the above embodiment would be to rotate the tuning fork 90 degrees and place the striker between the tines, which would allow the striker to contact the right tine when the fishing lure moved to the left and the left tine when the fishing lure moved right.

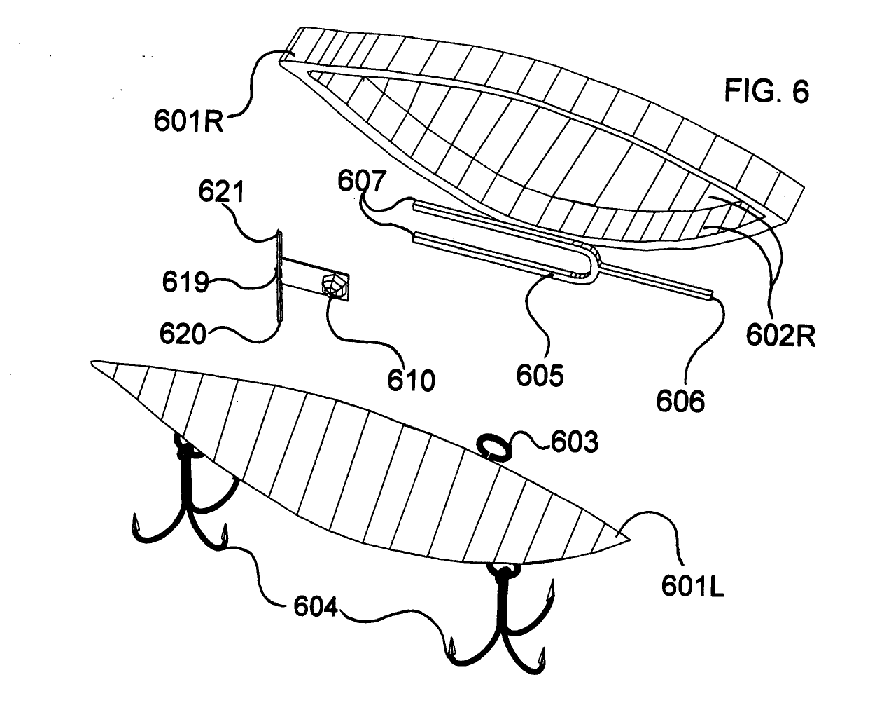

FIG. 6 is a partially expanded view of FIG. 5

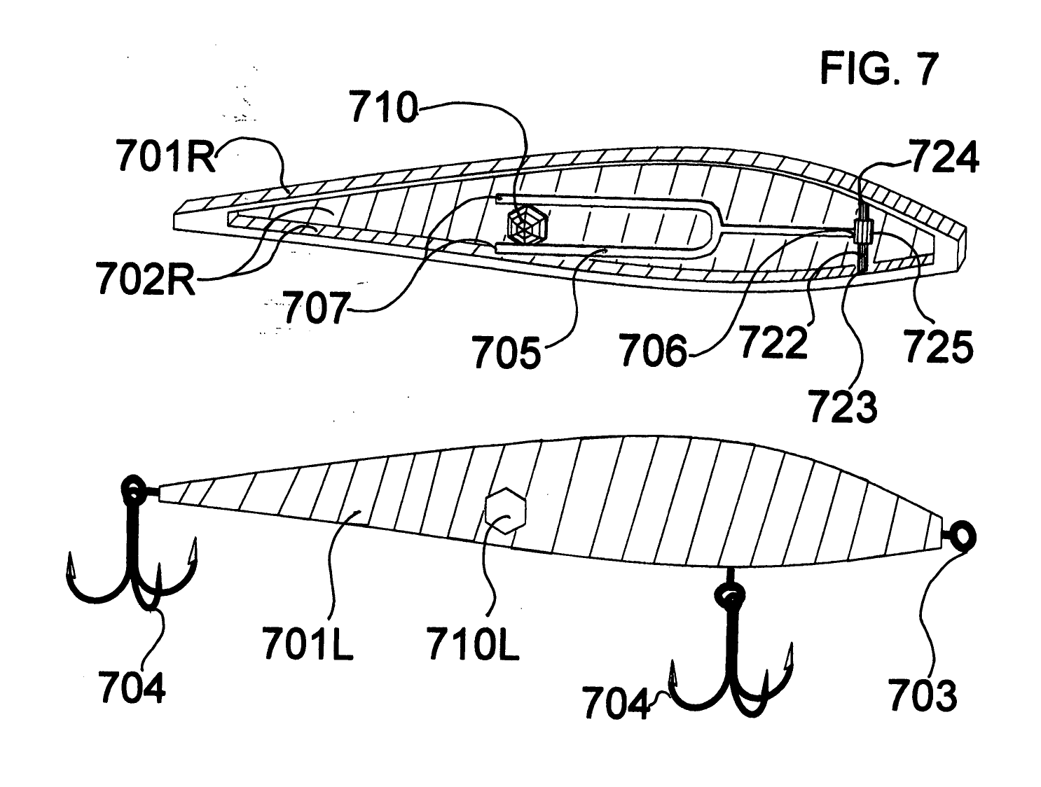

FIG. 7 Another embodiment of the disclosed invention comprised of a fish shaped housing 701R, 702L, an eyelet for attaching the fishing line 703, one or more generic fishing hooks 704, two strikers 710R, 710L mounted on the interior walls of the shell or through mounted in the walls of the shell, a tuning fork 705 having two ends, a first end, the stem end 706, and a second end, the tine end 707, the first end 706 is pivotally attached to the interior wall of the shell by some type of hinge. Any type of hinge will do as long as it can support the tuning fork and allow it to freely swing from side-to-side. For simplicity in this case we are using a sleeve 725 attached to the first end of the tuning fork 706 and rotatably mounted on a axle 722.

This class of fish shaped lure is distinguishable from the fish shaped lure in FIGS. 5 and 6 by its elongated shape, commonly referred to as a minnow shape; and the method of retrieval. This type of lure is retrieved in a variety of styles including but not limited to jerking, a steady constant retrieval, or a combination of the two, as well as used for trolling. The tuning fork hinge 722, 725 is attached to the interior wall of the shell 701. The exact point and angle at which the tuning fork hinge is attached to the shell will be dictated by the frequency produced and the volume of the sound the manufacture wishes the individual lure to transmit to the water. The striker 710R is embedded in the right half of the shell 701R and the second striker 710L is embedded in the left half of the shell 701L. The strikers are embedded in the shell in a location that will allow the tuning fork 705 to come into contact with the strikers as the tuning fork swings from side-to-side.

While the fishing lure is in use, the tuning fork swings from one side of the interior cavity of the shell to the other side, hitting a striker which starts the tuning fork to vibrating, at this point the tuning fork is transmitting sound through its stim 706 to the sleeve 725 into the axle 722 from the axle to the shell and then the sound is dispersed into the water. Since the tuning fork is already vibrating when it comes into contact with the second striker as it swings to the opposite side of the lure, it transmits a large burst of sound to the second striker which is transmitted to the shell then dispersed into the water. The strikers can also be through mounted in the wall of the shell allowing the strikers to transmit the burst of sound directly to the water. As the tuning fork rebounds from the second striker it starts vibrating ones again. This action is repeated over and over as long as the lure is in use. This embodiment of a fishing lure emits a loud burst of sound followed by a soft quite sound which in turn is followed by another loud burst.

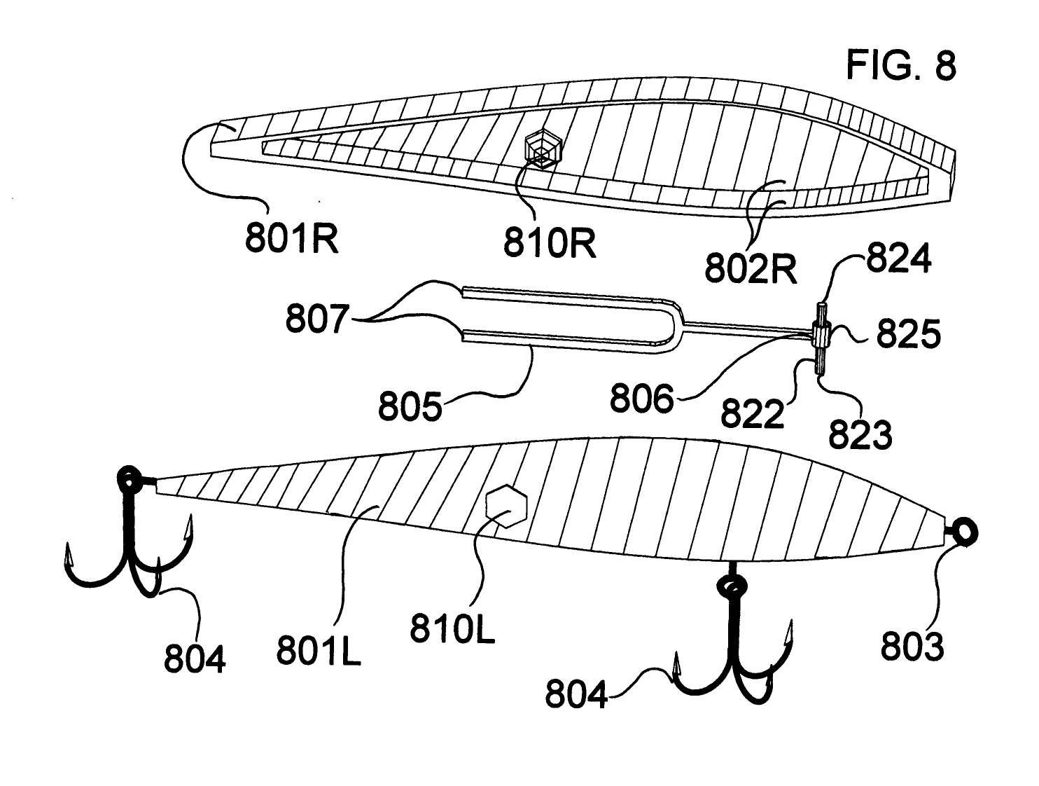

FIG. 8 is an expanded view of FIG. 7

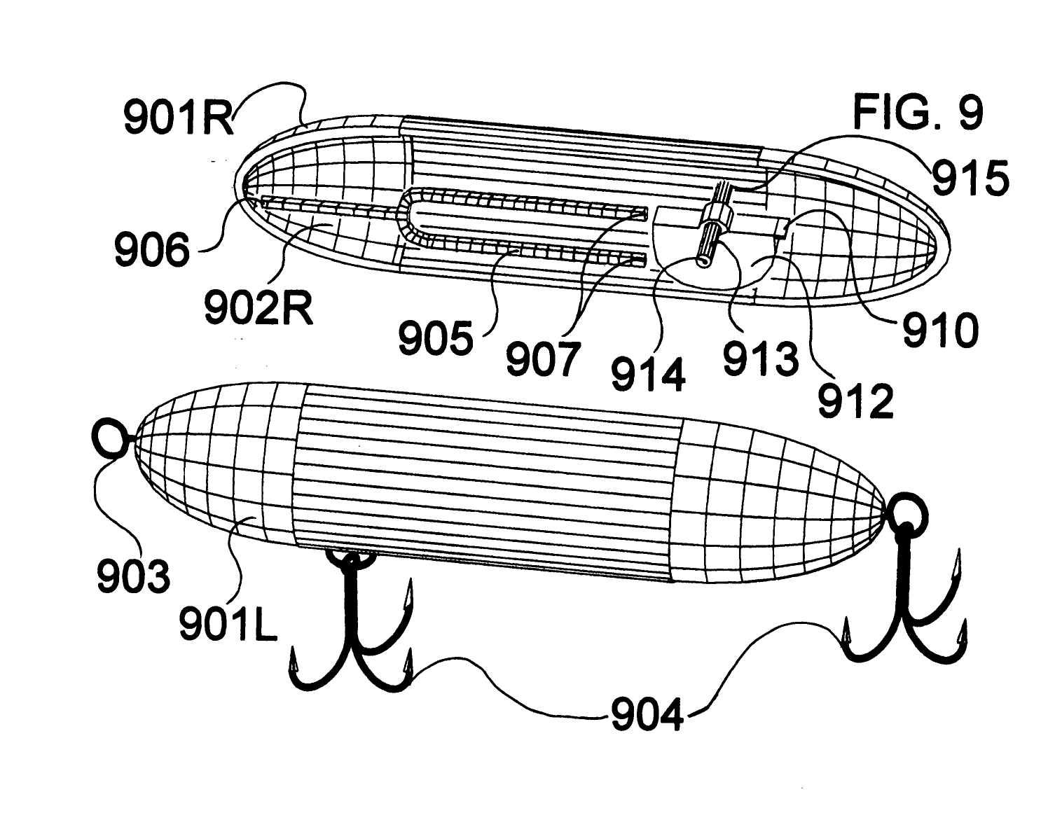

FIG. 9 this embodiment is a variation of a top water lure comprised of a waterproof shell 901R and 901L, the shell is tubular shaped and enclosed at each end with a parabolic shaped cap forming a one piece waterproof and somewhat capsule or torpedo shaped shell. This type of shell is most commonly formed by injection molding. The shell has been dissected into 901R, 901L. 901L has been removed to expose the interior of the fishing lure where the disclosed invention is housed. The shell has an interior wall 902R, 902L, an eyelet 903 that is attached to the exterior of the shell at one end to allow the fishing line to be attached, herein referred to as the front end of the shell. On the opposite end of the shell is mounted a generic treble hook 904, herein referred to as the back end or rear of the shell. The shell is weighted in such a manner as to allow one longitudinal portion of the shell to remain oriented downward while floating in water This portion is therein referred to as the bottom of the shell. A tuning fork 905 having a first end 906, the stem end. The stem end 906 is attached at some point to the interior wall of the shell, the exact placement of the tuning fork attachment will depend on several factors included, but not limited to, the balance of the overall unit, the frequency being produced by the tuning fork and the overall volume of the sound that is desired. In FIG. 9, the stem end of the tuning fork 906 is attached at the front of the shell for simplicity. The tuning fork having a second end, the tine end 907 which hangs free in the air space in the interior of the shell. What separates this embodiment from the rest is that the striker 910 is mounted on the weighted end of a pendulum. The pendulum can be of any design, in this case, we have chosen a half round shape. The striker can be mounted to allow the pendulum to rotate as many degrees from its resting position as desired before contacting the tuning fork. In this case, we have chosen 180 degrees. As the lure is jerked forward, the pendulum rotates in the opposite direction until the striker comes into contact with one of the tuning fork tines, which starts the tuning fork to vibrating and kicks the pendulum back in the opposite direction. An interesting side effect of using a pendulum is that once the striker hits the tuning fork, it rebounds and the pendulum continues to swing in an ever decreasing arc, until it looses all momentum or is activated again by a follow-up jerk on the fishing line. As the pendulum continues to swing, the lure moves in the opposite direction of the pendulum, in effect wiggling in the water, adding one more dimension to the lures ability to attract fish.

An alternative to the above would be to do away with the striker and allow the pendulum to strike the tuning fork.

A second alternative to the above embodiment would be to use a flexible material for a striker allowing the striker to bend as it comes into contact with the tuning fork, which will start the tuning fork to vibrating and allowing the pendulum to continue rotating past the tuning fork.

There are other design that will somewhat mimic the sound produced by a tuning fork, and although these devise can not produce the sound quality a tuning fork can we have been able to attract several species of fish with them. From a monetary standpoint, they are less expensive to produce, so we feel compelled to include them herein.

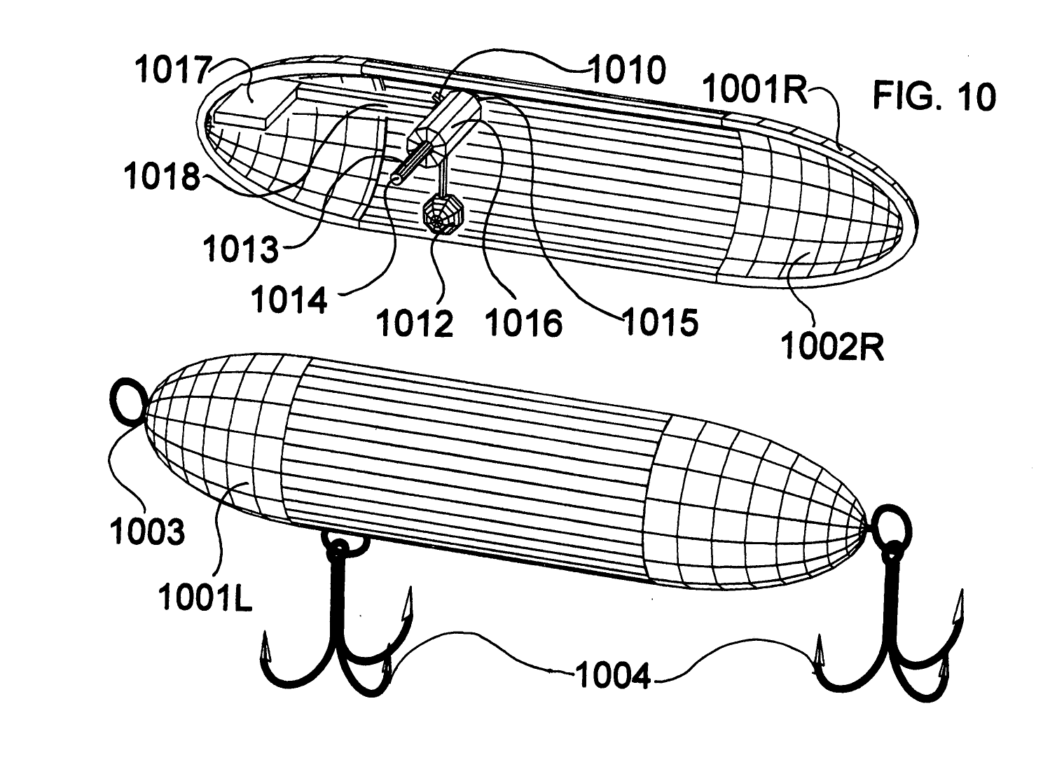

FIG. 10, this embodiment is a variation using the same housing elaborated on in FIGS. 1 through 4 in that the shell is tubular shaped, and enclosed at each end with a parabolic shaped cap forming a one piece waterproof, somewhat capful like or torpedo shaped shell. The tuning fork has been replaced with a single piece of spring steel (a comb) having two ends, a first end 1017 that is capable of being mounted to the interior wall of the shell, and a second end 1018 with a protruding tooth or teeth capable of producing sound when struck by an object or bent from its resting position and released. Any type of material will work in place of the spring steel that will vibrate producing sound if it is struck or bent from its resting position and released. For simplicity, a piece of spring steel is used herein; the spring steel is mounted to the interior wall of the shell at some point. The exact point will be dictated by the frequency and volume of the sound to be transmitted to the water; the spring steel can contain one or more protrusion (teeth) to produce one or more sounds, or vibration. For simplicity, FIG. 10 contains only one protruding tooth. This is the same type of instrument used to produce the sound in a music box; however, instead of being activated by a clock-work mechanism, it is powered by the action of a pendulum 1012. A nib or pick 1010 is mounted on the pendulum. This nib or pick can be mounted anywhere on the pendulum that will allow the nib or pick to contact the comb. For simplicity, in FIG. 10. the nib is mounted on the pendulum pivotal mounting sleeve 1016, and the pendulum pivotal mounting sleeve is rotatably mounted on the pendulum axle in such a way as to allow the pick 1010 to contact the tooth of the comb 1018; when the pendulum 1012 swings from its resting position. As the lure is jerked forward, the weighted end of the pendulum moves (in relation to the housing) toward the rear of the housing. This action rotates the nib or pick bringing the nib or pick into contact with the second end of the comb. The tooth, the nib or pick bends the tooth from its resting position to a loaded position as the pendulum continues past the fully loaded position and the tooth is released allowing it to freely rebound thus vibrating and producing a sound. The mounting end of the spring steel 1007 is solidly mounted to the interior wall of the shell thus the sound is transferred to the shell and then transmitted to the water.

A variation on the above embodiment would be to add enough weight to one or more of the teeth of the comb to allow the tooth or teeth to vibrate very slow allowing the vibration of the weighted tooth or teeth to produce movement of the fishing lure rather than sound.

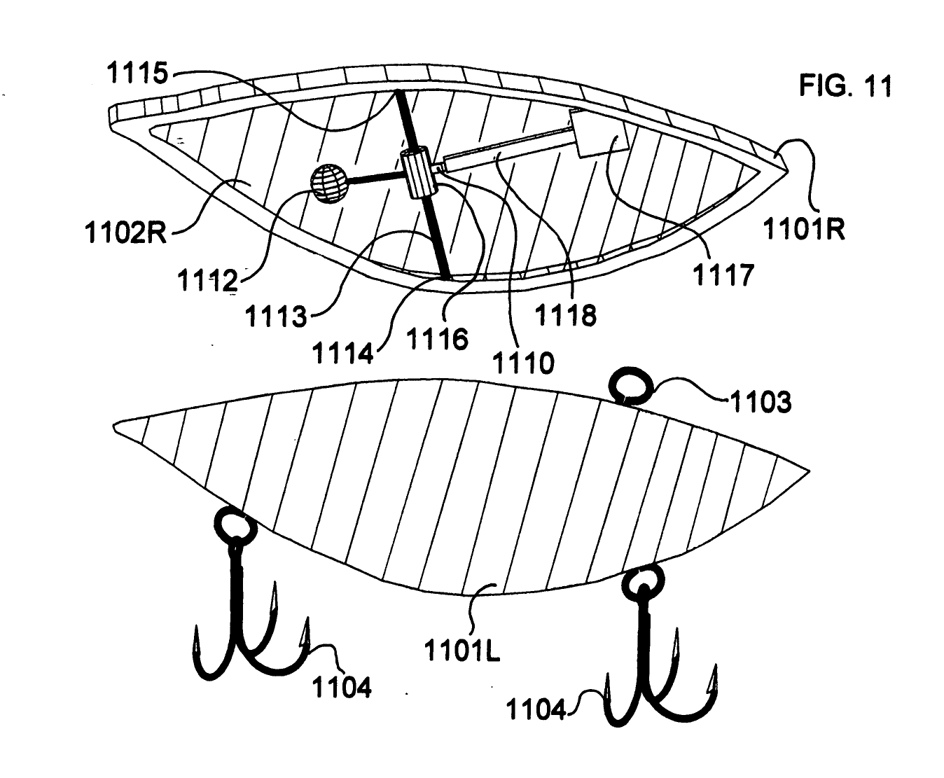

FIG. 11, in this next embodiment the housing (shell) 1101R, 1101L is identical to the one elaborated on in FIGS. 5 and 6 The shell is a short bodied waterproof, fish shape shell referred to in the industry as a crankbait. The other components are: an eyelet. 1306 to attach a fishing line to; one or more generic fishing hooks 1104, a piece of spring steel with one or more protruding teeth 1171, 1118 (comb), a nib or pick 1110, a pendulum 1112, a pendulum pivotal mounting sleeve 1116, a pendulum axle 1113.

The first end of spring steel, or comb 1171 is mounted on the interior wall of the shell at some point; the exact point will be dictated by the frequency and volume of the sound to be transmitted to the water. The spring steel or comb can contain one or more protrusion (teeth) to produce one or more sounds. For simplicity FIG. 11 contains only one tooth which is the same type of instrument used to produce the sound in a music box; however, instead of being activated by a clock-work mechanism it is powered by the side-to-side motion of a pendulum 1112. Any type of material will work in place of the spring steel comb that will vibrate producing sound if it is struck or bent from its resting position and released. For simplicity, a piece of spring steel is used here for a comb. A nib or pick 1110 is mounted on the peripheral surface of the pendulum pivotal mounting sleeve 1116 which doubles as a nib drum. The pendulum pivotal mounting sleeve 1116 is rotatably mounted on the pendulum axle 1113 in such a way as to allow the nib or pick 1110 to contact the tooth of the spring steel comb 1118 when the pendulum 1112 swing from side-to-side. As the pendulum swings from one side of the lure to the opposite side the nib or pick bends the tooth from its resting position to a loaded position. As the pendulum continues past the fully loaded position the spring steel tooth is released allowing it to freely rebound thus vibrating and producing a sound. The spring steel is solidly mounted to the interior wall of the shell thus the sound is transferred to the shell and then transmitted to the water.

The aforementioned embodiment should work well in this as well as any type or shape of fishing lure that oscillates from side-to-side while in use.

FIG. 12 this embodiment is a variation of that elaborated on in FIGS. 1, through 4. The difference is that the striker has been replaced with a pendulum 1212, which is attached to the pendulum pivotally mounting sleeve 1216. The pendulum pivotally mounting sleeve is rotatably mounted on the pendulum axle 1213 and the pendulum axle has two ends the first end 1214 is mounted in the interior wall of the left half of the shell 1202L and the second end is mounted in the interior wall of the right half of the shell 1202R. The pendulum is mounted in such a manner as to allow the weighted end of the pendulum to swing back and strike one of the tuning forks tines as the fishing lure is jerked forward, causing the tuning fork to vibrate producing sound that can be transmitted into the water.

A variation of the above embodiment would be to add a spring to the pendulum to hold the pendulum in a ready position. The spring should be capable of holding the pendulum in a ready position, and yet, should be easily overcome allowing the pendulum to strike the tuning fork once the fishing lure is jerked forward, which would allow the pendulum to be mounted in any position.

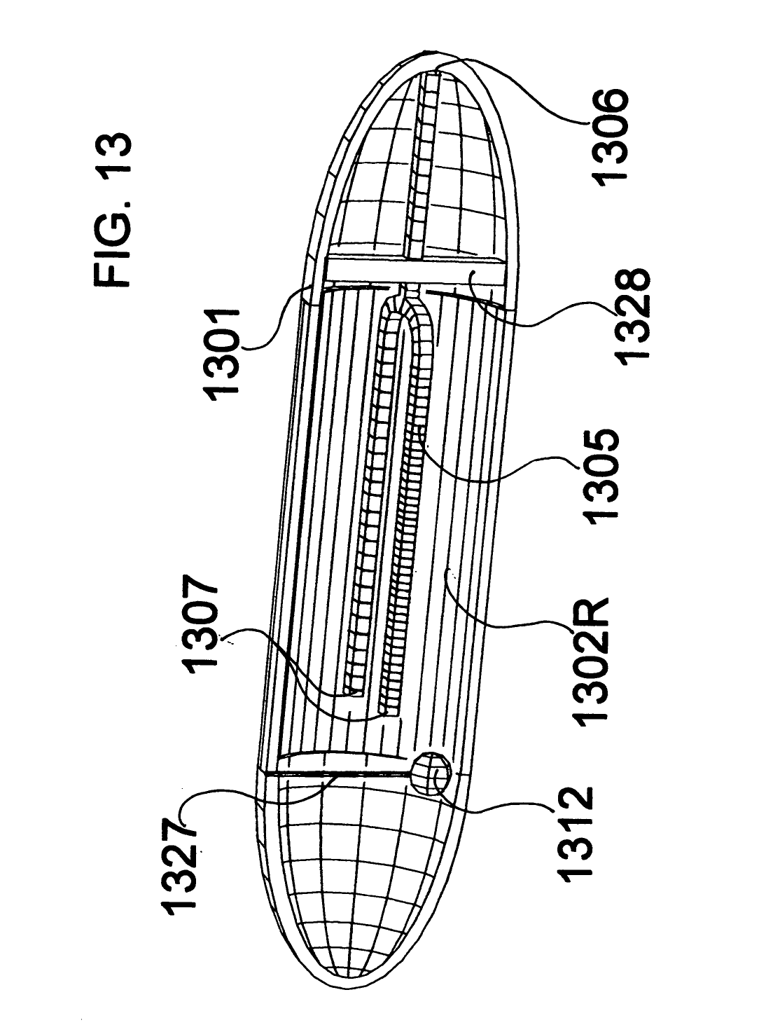

A second variation of the above embodiment would be to place a nib or pick on the pendulum or the pendulum pivotal mounting sleeve and mount the pendulum where the nib or pick would contact the tuning fork as the pendulum is activated allowing the nib to bend one of the tuning fork tines and release it causing the tuning fork to vibrate FIG. 13 this embodiment is a variation of that elaborated on in FIGS. 1 through 4. The only difference is the striker has been replaced with a small weight 1312 that is attached to a string, spring or a thin piece of solid plastic or any type of material that can withstand repeated bending without breaking 1327. The striker 1312 can be any shape and can be made of any material that will start the tuning fork vibrating when it strikes it. The striker 1312 can be hung from the inside top wall of the housing. If a spring or a piece of plastic strong enough to hold the weight of the striker upright is used the striker support can be mounted to the inside wall of the shell at the bottom of the shell or any angle between vertical and horizontal. The criteria for mounting the striker is that the striker must strike the tuning fork when the fishing lure is jerked forward, and then the striker must rebound allowing the tuning fork to vibrate. A side effect of using the above striker or any type of pendulum for a striker is that the lure continues to oscillate (for a short time) in the water after all input has stopped, this action adds another dimension to the fishing lures ability to attract fish.

A variation of the above embodiment would be to remove the tuning fork and use the striker alone to make sound by allowing the striker to hit the interior wall of the shell. This would have the added advantage of add movement to the fishing lure as the striker continues to swing after initial activation causing the fishing lure to move in the water.

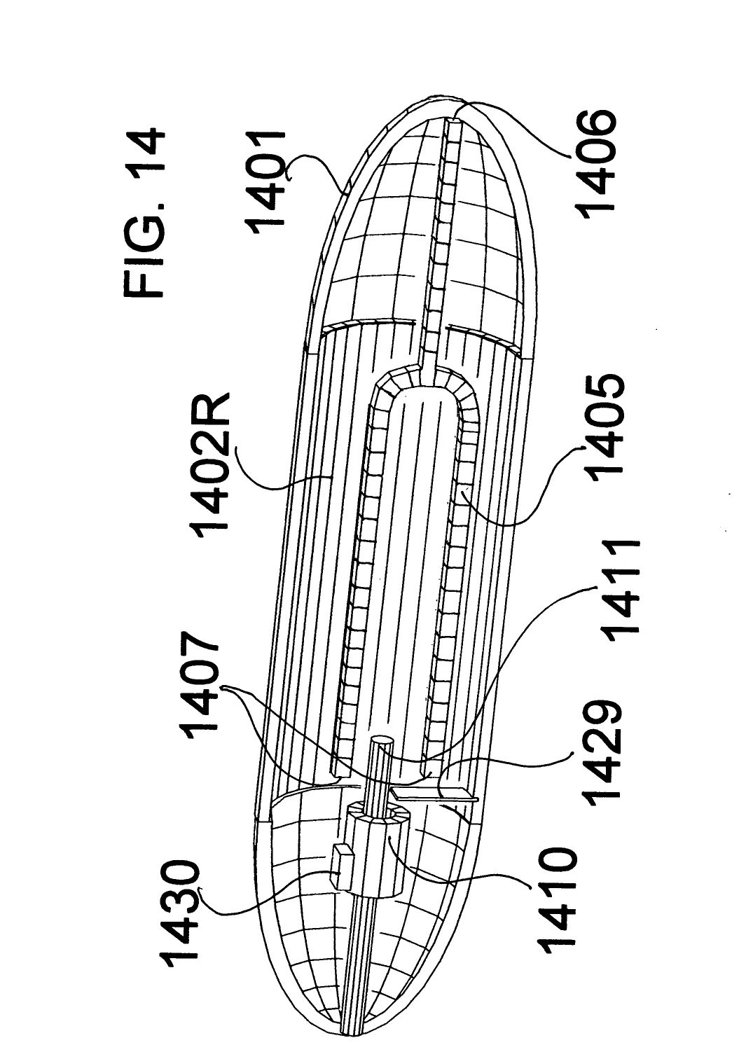

FIG. 14 this embodiment is another variation of that elaborated on in FIGS. 1 through 4. What singles out this embodiment is a leaf spring 1429 that is mounted in such a position as to allow the spring to accelerate the striker 1410 back to its starting point once the striker strikes the tuning fork. This design eliminates the need to angle the striker guide to allow the striker to slide back to its resting position.

A variation of the above embodiment would be to use a coil spring to attach the striker to the shell said spring would return the striker to its starting position.

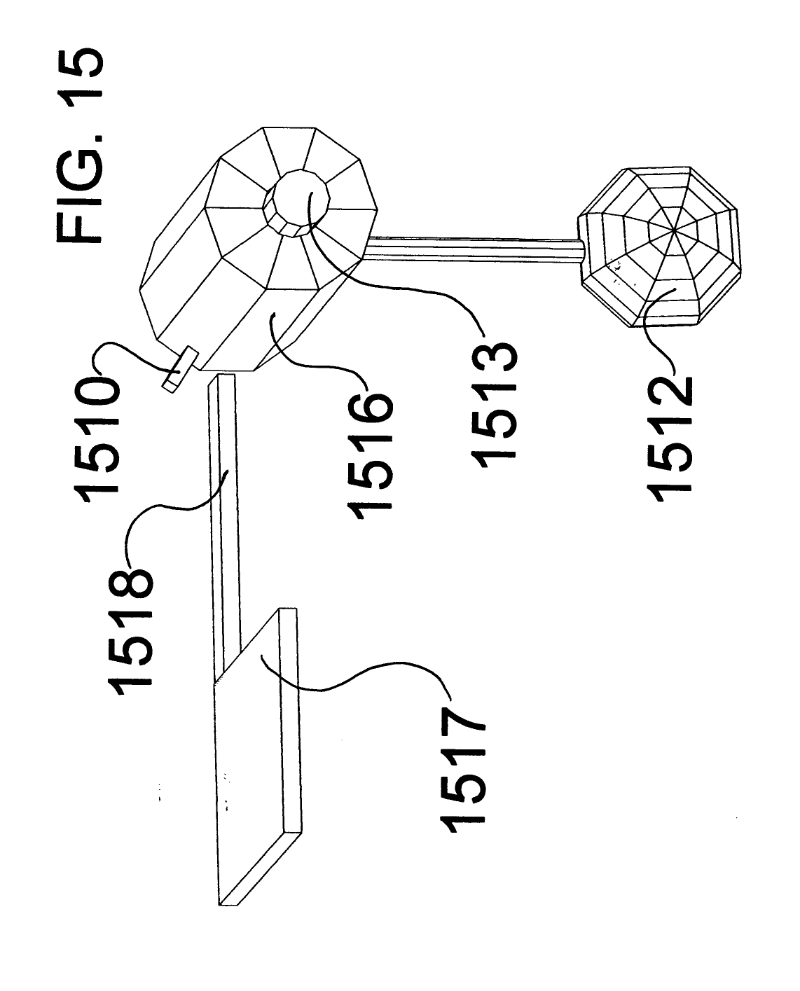

FIG. 15 is an enlarged view of one embodiment of the apparatus without a shell comprised of: a pendulum 1512, a pendulum pivotal mounting sleeve 1516, a nib or pick 1510, a comb that consists of the mounting plate 1517 and a tooth 1518.

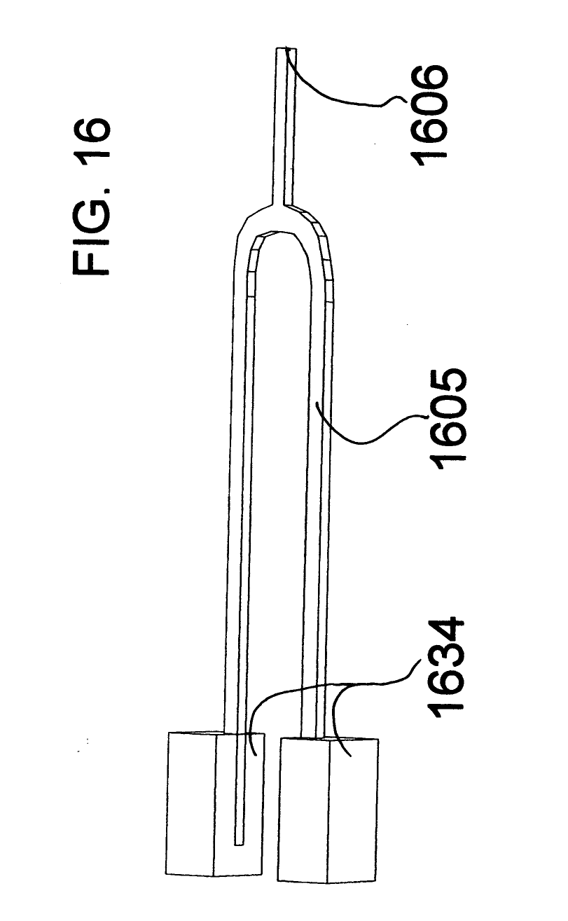

FIG. 16 is an enlarged view of a tuning fork 1605 with weights attached to the tines 1634. This type of tuning fork can be used to produce more of a movement in a fishing lure rather than a sound. Also, this type of tuning fork can be made to vibrate by the movement of the lure alone, by striking the tuning fork or by plunking the tuning for with a nib or pick.

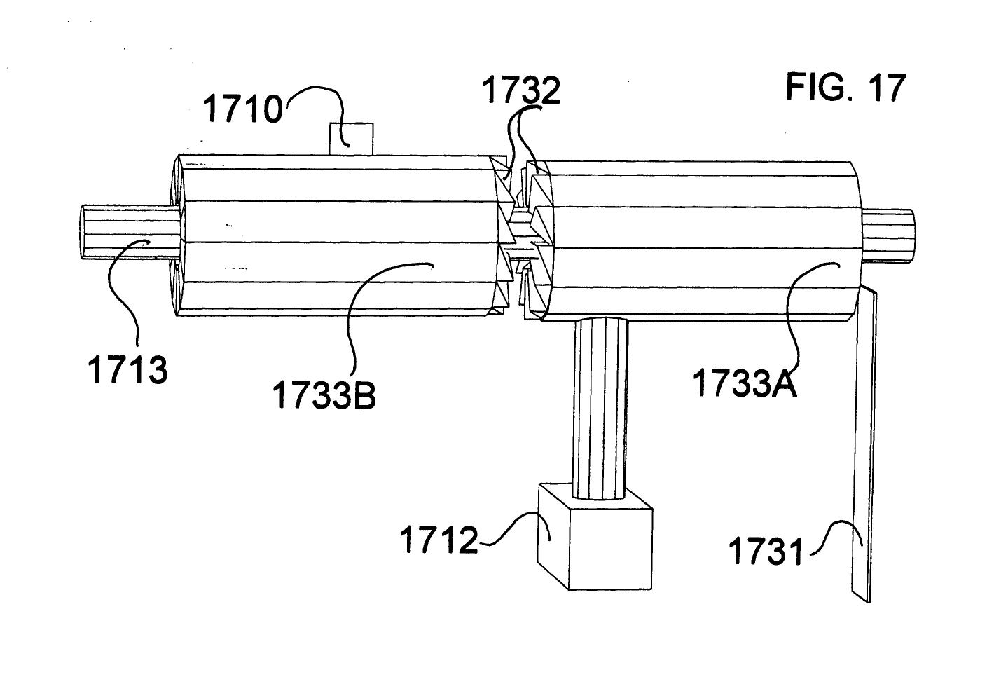

FIG. 17 is a close-up of an alternate method of powering the disclosed invention. This apparatus transforms the pendulums bidirectional swinging motion to a unidirectional

rotating motion via a ratcheting gear allowing the drum and nibs to rotate in a single direction. The apparatus is comprised of a pendulum 1712, a pendulum axle 1713, and a nib or pick 1710, a pendulum pivotal mounting sleeve 1733A, a nib or pick drum 1733B, the ratcheting gears 1732, and a retainer spring 1731.

1. An apparatus capable of being placed in a large variety of fishing lures. The apparatus is capable of emitting a plurality of sounds to attract fish, the apparatus comprised of:
(a) a watertight somewhat tubular shaped generic shell which is referred to in the industry as a top water plug;
(b) a air space within said shell capable of containing the apparatus and enough air to float the apparatus and said shell;
(c) a tuning fork having a stem on the first end and tines on the second end, the first end being solidly mounted to the interior wall of the shell, the tines hanging free in the air space;
(d) a striker guide having two ends. The first end of the striker guide is attached to the interior wall of the shell at the bottom of the shell forward, and below the second end. The second end of the striker guide is attached to the interior wall of the shell at the top of the shell rearward and above the first end thus the striker guide forms an angle in relationship the shell;
(e) a striker is slide mounted on the striker guide, resting at the forward bottom end of the striker guide. Said striker being capable of sliding up the striker guide and striking the tuning fork at some point once the striker is activated by the fishing lure being jerked forward;

1. The apparatus of claim 1 is further comprised of a tuning fork stem support to help support the tuning fork and to aid in transmitting the sound produced by the tuning fork to the shell for dispersal into the water.

2. The apparatus of claim 1 wherein the means of supporting the striker is a striker guide tube having two ends. The first end being attached to the bottom of the shell forward of the second end, and a second end that is rearward and above the first end at an angle stopping just short of the tuning fork but close enough to the tuning fork to allow the striker to strike the tuning fork without being ejected from the striker guide once the striker is accelerated up the striker tube by jerking the fishing lure forward.

3. The apparatus of claim 1, wherein the striker is a pendulum hanging from an axle which is mounted in the upper portion of the interior wall of the shell. The pendulum having a first end which is pivotally mounted on an axle, and a second weighted end which swing free in a vertical arc intersecting the tuning fork, said end is used to strike the tuning fork causing the tuning fork to vibrate.

4. The apparatus of claim 3, wherein the pendulum is mounted in such a way that its movement is a horizontal arc intersecting the tuning fork.

5. The apparatus of claim 4 wherein a spring capable of being overcome by the movement of the fishing lure holds the pendulum in a ready position allowing the pendulum to be mounted at any angle in the fishing lure.

6. An apparatus capable of being placed in a large verity of fishing lures, the apparatus is capable of emitting a plurality of sounds to attract fish, the apparatus comprised of:
(a) a short bodied waterproof generic fish shaped shell referred to in the industry as a crank bait, said shell being the type of fishing lure that oscillates from side-to-side while in use;
(b) a cavity within said shell capable of containing the apparatus;
(c) a tuning fork having a stem on the first end and tines on the second end, the first end being solidly mounted to the interior wall of the shell and the tines hanging free in the air space;
(d) a pendulum axle, having a first end and a second end, the first end being mounted in the interior wall at the top of the fishing lure, the second end of the pendulum axle being mounted in the interior wall at the bottom of the fishing lure;
(e) a pendulum rotatably mounted on said pendulum axle, that allows the pendulum to swing toward the right and left side of the interior walls of the fishing lure, striking the tuning fork in one direction as well as the interior wall of the shell when swinging in the opposite direction.

7. The apparatus of claim 6 wherein the striker is slide mounted on a striker guide; the striker guide being mounted in such a position as to allow the striker to strike the tuning fork while the fishing lure is in use; the striker guide having two ends, a first end and a second end. The first end being mounted to the right side of the interior wall of the shell, and the second end being mounted to the left side of the interior wall of the shell.

8. The apparatus of claim 6 wherein the striker is housed in a striker guide tube. The striker guide tube being mounted in such a position as to allow the striker housed within it to strike the tuning fork while the fishing lure is in use. The striker guide tub having two ends, a first end mounted to the interior wall of the shell and a second end stopping just short of touching the tuning fork allowing the striker strike the tuning fork as the fishing lure oscillates from side-to-side.

9. The apparatus of claim 6 wherein a through hole is incorporated in the side of the fishing lure opposite the tuning fork where the pendulum strikes the shell.

10. The apparatus of claim 9 wherein a small waterproof drum is mounted in the hole allowing the striker to strike the tuning fork while swinging in one direction and the drum while swinging in the opposite direction.

11. An apparatus capable of being placed in a large variety of fishing lures and the apparatus is capable of emitting a plurality of sounds to attract fish. The apparatus comprised of:
(a) a long slender bodied waterproof generic fish shaped shell referred to in the industry as a jerk bait or minnow. The said shell being the type of fishing lure that oscillates form side-to-side while in use;
(b) a cavity within said shell capable of containing the apparatus;
(c) two strikers, a first striker being mounted in the interior wall of the right side of the fishing lure, and a second striker being mounted in the interior wall of the left side of the fishing lure.
(d) a tuning fork having a stem on the first end and tines on the second end. The tuning fork having a hinge attached to the first end and the first end being hinge mounted to the interior wall of the shell with the tine end being capable of rotating from side-to-side to hit the aforementioned strikers, said hinge can be of any design capable of supporting the tuning fork.

12 The apparatus of claim 11 wherein a hole is incorporated in both the right and left sides of the shell.

13 The apparatus of claim 12 wherein the strikers are mounted in the holes in the right and left sides of the shell with a watertight seal, allowing the strikers to emit sound directly into the water.

14. The apparatus of claim 11 wherein while the fishing lure is in use, the tuning fork swings from the first side to the second side of the fishing lure striking the striker in the second side, in the process gaining and storing energy in the form of vibrating whereupon the tuning fork rebounds as the fishing lure changes direction causing the tuning fork to swing back to the first side of the fishing lure. Upon making contact with the striker in the first side, the tuning fork transfers a burst of the stored energy to the respective striker in the form of vibrations. The striker, in turn, transfers the vibrations to the shell, which in turn emits them into the water. As the tuning fork again rebounds from the first side energy is again stored in the tuning fork in the form of vibrating, the tuning fork swings once again to the second side to repeat the process over and over as long as the fishing lure is in use.

15. The apparatus of claim 1, wherein the striker is a weight suspended from the top inside wall of the shell by a flexible material such as a string, spring, solid piece of plastic or any type of flexible material.

16. The apparatus of claim 1, wherein the striker is a weight supported by a spring or thin piece of flexible material mounted to the interior wall of the shell at any angle. The flexible material being capable of supporting the weight of the striker, said material being flexible enough to be overcome by the movement of the fishing lure allow the weight to strike the tuning fork.

17. The apparatus of claim 1, wherein the diameter, length, weight and the distribution of the weight of the tuning fork tines is adjusted to allow the tuning fork to produce any hertz required by the manufacture.

18. An apparatus capable of being placed in a large variety of fishing lures, the apparatus being capable of emitting a plurality of sounds to attract fish. The apparatus comprising:
(a) a watertight somewhat tubular shaped generic shell, referred to in the industry as a top water plug;
(b) an air space within said shell capable of containing the apparatus and enough air to float the apparatus and said shell;
(c) a comb containing one or more teeth. The comb is of the same general design as those used in music boxes;
(d) a pendulum axle, having a first end and a second end, the first end being mounted in the interior wall at the right side of the fishing lure, and the second end of the pendulum axle being mounted in the interior wall at the left side of the fishing lure;
(e) a pendulum, rotatably mounted on said pendulum axle, thus allowing the pendulum to swing toward the front and rear of the fishing lure;
(f) a pendulum pivotal mounting sleeve which is attached to the mounting end of the pendulum, the peripheral surface of said pendulum pivotal mounting sleeve being used as a drum to mount the nib(s) (pick);
(g) a nib(s), (pick), which is attached to the peripheral surface of the pendulum pivotal mounting sleeve (the drum), in such a way as to allow the nib(s), once the pendulum is activated, to bend the tooth or teeth of the comb from their resting position to a loaded position and release them allowing them to freely rebound;

19. The apparatus of claim 18, wherein the diameter, length, weight and the distribution of the weight of the teeth of the comb is changed to allow the comb to vibrate at any hertz required by the manufacture;

20. The apparatus of claim 18, wherein the nib(s) can be mounted on any surface of the pendulum, and the position of the pendulum can be adjusted so that the nib(s) can activate the comb by bending the tooth or teeth from there resting position to a loaded position then release them;

21. The apparatus of claim 18, wherein the action of the pendulum swinging causes the fishing lure to oscillate in the water for a short time after external influence has ceased;

22. An apparatus capable of being placed in a large variety of fishing lures, the disclosed apparatus being capable of emitting a plurality of sounds to attract fish; the apparatus comprised of:
(a) a short bodied waterproof generic fish shaped shell referred to in the industry as a crankbait. Said shell being the type of fishing lure that oscillates from side-to-side while in use;
(b) a cavity within said shell capable of containing the disclosed apparatus;
(c) a comb containing one or more teeth, the comb is of the same general design as those used in music boxes;
(d) a pendulum axle, having a first end and a second end, and the first end being mounted in the interior wall at the top of the fishing lure, the second end of the pendulum axle being mounted in the interior wall at the bottom of the fishing lure;
(e) a pendulum, rotatably mounted on said pendulum axle, thus allowing the pendulum to swing from the right to the left side of the fishing lure;
(f) a pendulum pivotal mounting sleeve which is attached to the end of the stem of the pendulum. The peripheral surface of said pendulum pivotal mounting sleeve is used as a drum to mount the nib(s) (pick);
(g) a nib(s), (pick), which is attached to the peripheral surface of the pendulum pivotal mounting sleeve (the drum), in such a way as to allow the nub(s), while the pendulum is swinging from side-to-side, to come into contact with the tooth or teeth of the comb.

23. The apparatus of claim 22, wherein while the fishing lure is in use, the pendulum swings from side-to-side which in turn rotates the nib(s) mounted on the peripheral surface of the pendulum pivotal mounting sleeves, this action bends the teeth of the comb from their resting position to a loaded position and releases them allowing the teeth to freely rebound causing the teeth to vibrate.

24. The apparatus of claim 22, wherein while the fishing lure is in use, the pendulums weighted end swings from side-to-side striking the right and left interior walls of the fishing lure producing sound;

25. The apparatus of claim 22, wherein the shell is designed with through holes in it where the weighted end of the pendulum strikes the interior walls of the shell and disks of suitable size as well as made of a material that produces the most suitable sound to attract the targeted species of fish are mounted in the holes.

26. The apparatus of claim 25, wherein the disks through mounted in either side of the fishing lure have several corrugated rings around their circumference, in effect turning the disks into small mechanically actuated speakers.

27. The apparatus of claim 22, wherein the diameter, length, weight and the distribution of the weight of the teeth of the comb is changed to allow the comb to vibrate at any hertz required by the manufacture.

28. The apparatus of claim 6, wherein the diameter, length, weight and distribution of the weight of the tuning fork tines is adjusted to allow the tuning fork to produce any hertz required by the manufacture.

29. The apparatus of claim 11, wherein the diameter, length, weight and distribution of the weight of the tuning fork tines is adjusted to allow the tuning fork to produce any hertz required by the manufacture.

30. An apparatus capable of being placed in a large variety of fishing lures, the apparatus is capable of emitting a plurality of sounds to attract fish. The apparatus comprising:
(a) a watertight somewhat tubular shaped generic shell, referred to in the industry as a top water plug;
(b) an air space within said shell capable of containing the apparatus and enough air to float the apparatus and said shell;
(c) a tuning fork having a stem on the first end and tines on the second end. The first end being solidly mounted to the interior wall of the shell, and the tines hanging free in the air space;
(d) a pendulum axle, having a first end and a second end. The first end being mounted in the interior wall at the right side of the fishing lure, and the second end of the pendulum axle being mounted in the interior wall at the left side of the fishing lure;
(e) a pendulum pivotal mounting sleeve which is attached to the mounting end of the pendulum, and is rotatably mounted on said pendulum axle thus allowing the pendulum to freely swing back and forth, or in a 360 degree circle;
(f) a striker mounted on the pendulum in such a manner as to allow the striker to contact the tuning fork at some point as the pendulum swings.

31. The apparatus of claim 30, wherein the striker is made of a material that will bend, allowing the striker to strike the tuning fork, causing it to vibrate while allowing the pendulum to continue rotating past the point of contact completing a circle.

32. The apparatus of claim 30, wherein the pendulums swing action causes the fishing lure to oscillate in the water adding movement to the sound emitted by the fishing lure.

33. The apparatus of claim 32, wherein the tuning fork is removed and the oscillation induced in the fishing lure by the pendulum is used to attract fish.

34. An apparatus capable of being placed in a large variety of fishing lures. The apparatus is capable of emitting a plurality of sounds to attract fish. The apparatus comprised of:
(f) a watertight somewhat tubular shaped generic shell, referred to in the industry as a top water plug;
(g) a air space within said shell capable of containing the apparatus and enough air to float the apparatus and said shell;
(h) a tuning fork having a stem on the first end and tines on the second end. The first end being solidly mounted to the interior wall of the shell and the tines hanging free in the air space;
(i) a striker guide having two ends; the first end of the striker guide is attached to the interior wall of the shell at the front end of the fishing lure, and the second end of the striker guide hinge free in the air space;
(j) a striker, in that the said striker is slide mounted on the striker guide, said striker being capable of sliding along the striker guide and striking the tuning fork at some point once the striker is activated by the fishing lure being jerked forward.
(k) a flat piece of spring steel, said spring steel is mounted on the interior wall of the shell in such a position as to allow the striker to contact and bend the spring steel from its resting position to a loaded position as the striker strikes the tuning fork. The spring then accelerates the striker in the opposite direction returning the striker to its starting position.

35. The apparatus of claim 34, wherein a coil spring is substituted for the piece of flat spring steel. One end of the coil spring being attached to the striker and the other end of the coil spring being attached to the interior wall of the shell.

36. The shells of all claims wherein the atmospheric pressure within the shells is significantly reduced. Reducing the atmospheric pressure within the shell can localize the points at which the sound is transmitted into the water to the contact points of the disclosed invention, and can extend the longevity of the sound or movement produced by the disclosed invention by decreasing the air resistance the disclosed invention must overcome.

37. The apparatuses of claims 18 and 22 wherein any type of hinge is be used to attach the pendulum to the interior wall of the shell.
